(19) United States
(12) Patent Application Publication
(10) Pub. No.: US 2014/0295147 A1
(43) Pub. Date: Oct. 2, 2014

(54) INK JET RECORDING METHOD AND RECORDED MATTER

(71) Applicant: Seiko Epson Corporation, Tokyo (JP)

(72) Inventors: Tomoyuki Okuyama, Chino (JP); Shohei Shiono, Matsumoto (JP)

(73) Assignee: Seiko Epson Corporation, Tokyo (JP)

(21) Appl. No.: 14/219,128

(22) Filed: Mar. 19, 2014

(30) Foreign Application Priority Data
Apr. 1, 2013 (JP) 2013-075754

(51) Int. Cl. B41J 2/04; B41J 2/155; B41J 2/15

(52) U.S. Cl. CPC B41J 2/04; B41J 2/15; B41J 2/155
USPC 428/195.1; 347/37; 347/42; 347/100

(57) ABSTRACT

The ink jet recording method according to the invention records an image by discharging liquid droplets of an ink composition from a recording head and allowing the droplets to adhere to a recording medium. The ink composition contains an alkanediol having 6 or less of carbon atoms and having a normal boiling point of 240° C. or more in an amount of 3% by mass or more and 20% by mass or less. The ink droplets of the ink composition have a volume of 5 pL or more and 30 pL or less per droplet. The recording head is a serial scanning head or line scan head. In the serial scanning head, the image resolution in the recording medium-transporting direction is 6 times or less the head resolution in the transporting direction.

Priority is claimed under 35 U.S.C. §119 to Japanese Application No. 2013-075754 filed on Apr. 1, 2013, which is hereby incorporated by reference in its entirety.

### BACKGROUND

1. Technical Field

The present invention relates to an ink jet recording method and a recorded matter prepared by the method.

2. Related Art

A recording method using an ink jet recording system is performed by discharging fine liquid droplets of an ink (ink droplets) and allowing the ink droplets to fly and attach to (land on) a recording medium such as paper. Because of recent innovative progress in the ink jet recording technology, the recording method using an ink jet recording system has been also employed in the field of highly fine image recording (image printing), which was ever achieved only by photograph or offset printing.

In order to perform recording with higher fineness by the ink jet recording system, the volume of ink droplets to be discharged must be significantly small, such as several picoliters, and the diameter and the spacing of nozzles for discharging an ink are further reduced. For example, JP-A-2009-287003 discloses an ink jet recording ink containing a specific alkanediol, such as 1,2-hexanediol, that can be applied to a recording head corresponding to high image quality (recording head composed of first nozzles each having a relatively short passage and second nozzles each having a relatively long passage alternately arranged at intervals of less than 30 μm).

Unfortunately, since the ink jet recording ink described in JP-A-2009-287003 contains a penetrant having a low boiling point, the volatile organic compounds (VOC) in the organic solvent from a recorded image disadvantageously increase. Accordingly, a reduction in the volume of VOC by using a penetrant having a high normal boiling point may be effective. However, an ink jet recording ink merely containing a penetrant having a high normal boiling point is inferior in drying property at the time of adhering to a recording medium. Consequently, the ink on the recording medium overflows to cause bleeding of the image or to increase the granular quality of the image, resulting in failure to form a satisfactory image.

Separately, in order to enhance the recording speed, a method of, for example, using a line scan head, using of a serial scanning head with a reduced number of passes, or increasing the volume of ink per droplet to be discharged is employed. However, a reduction in the drying property of an ink adhered to a recording medium as described above is apt to further decrease the image quality of the recorded image with speeding up of recording.

### SUMMARY

An advantage of some aspects of the invention is to provide a recording method that can reduce the VOC generation from a recorded image and can achieve compatibility between high speed recording and high image quality.

An advantage of some aspects of the invention is to solve at least a part of the disadvantages described above, and the invention can be realized as the following aspects or application examples.

### Application Example 1

An embodiment of the ink jet recording method according to the invention is an ink jet recording method of recording an image by allowing ink droplets of an ink composition discharged from a recording head to adhere onto a recording medium, wherein the ink composition contains 3% by mass or more and 20% by mass or less of an alkanediol having 6 or less carbon atoms and having a normal boiling point of 240° C. or more; the ink droplets of the ink composition have a volume of 5 pL or more and 30 pL or less per droplet; and the recording head is a serial scanning head or a line scan head, wherein in a case of the recording head being a serial scanning head, the image resolution in the recording medium-transporting direction is 6 times or less the head resolution in the transporting direction.

In the ink jet recording method of application example 1, the VOC generation from the recorded image can be reduced, and compatibility between high speed recording and high image quality can be achieved.

### Application Example 2

In application example 1, the recording head can have a resolution of 200 dpi or more and 800 dpi or less per unit length.

### Application Example 3

In application example 1 or 2, the image resolution in the recording medium-transporting direction is 1200 dpi or less, and the image resolution in a direction crossing the transporting direction is 1200 dpi or less.

### Application Example 4

In any one of application examples 1 to 3, in a case of the recording head being a line scan head, the transporting speed of the recording medium in the transporting direction is 30 cm/s or more.

### Application Example 5

In any one of application examples 1 to 4, the alkanediol has a branched structure.

### Application Example 6

In any one of application examples 1 to 5, the alkanediol is 3-methyl-1,5-pentanediol.

### Application Example 7

In any one of application examples 1 to 6, the recording head can discharge ink droplets having different sizes to form the image.

### Application Example 8

An embodiment of the recorded matter according to the invention is a recorded matter prepared by the ink jet recording method according to any one of application examples 1 to 7.

### DESCRIPTION OF EXEMPLARY EMBODIMENTS

Preferred embodiments of the invention will now be described. The embodiments described below are merely examples of the invention. It is apparent that the invention is not limited to the following embodiments and includes various modifications made within the scope not changing the gist of the invention.

In the invention, the term “image” refers to a recorded pattern formed by groups of dots and includes text recording and solid recording.

An ink jet recording method according to this embodiment records an image by allowing ink droplets of an ink composition discharged from a recording head to adhere onto a recording medium. The ink composition contains 3% by mass or more and 20% by mass or less of an alkanediol having 6 or less carbon atoms and having a normal boiling point of 240° C. or more. The droplets of the ink composition have a volume of 5 pL or more and 30 pL or less per droplet. The recording head is a serial scanning head or a line scan head. In the case of the recording head being a serial scanning head, the image resolution in the recording medium-transporting direction is 6 times or less the head resolution in the transporting direction.

The ink composition used in the ink jet recording method according to the embodiment will now be described, and the ink jet recording method will be described later.

### 1. Ink Composition

### 1.1. Alkanediol

The ink composition according to the embodiment contains an alkanediol having 6 or less carbon atoms and having a normal boiling point of 240° C. or more (hereinafter, also referred to as “specific alkanediol”). Examples of such a specific alkanediol include 3-methyl-1,5-pentanediol, 1,6-hexanediol, and (R)-(+)-2-methyl-1,4-butanediol. The alkanediol preferably has a branched structure from the viewpoint of better permeability and wettability. Among these alkanediols, 3-methyl-1,5-pentanediol is particularly preferred. The ink composition containing such a specific alkanediol can reduce the VOC generation from a recorded image.

Since 3-methyl-1,5-pentanediol has a high boiling point, it functions as a moisturizing agent when it presents at a recording head and also functions so as to weaken the hydrogen bond of water when it adhered to a recording medium to accelerate drying of the image. As a result, high speed recording is realized.

The content of the specific alkanediol in the ink composition is 3% by mass or more and 20% by mass or less, preferably 5% by mass or more and 20% by mass or less, and most preferably 5% by mass or more and 10% by mass or less. The ink composition containing the specific alkanediol within the range mentioned above is excellent in the balance between the permeability and the drying property of the ink and can record excellent images. On the contrary, a content of the specific alkanediol less than the above-mentioned range decreases the permeability of the ink into a recording medium, which may lead to overflow of the ink on the recording medium, resulting in, for example, bleeding of the recorded image. A content of the specific alkanediol higher than the above-mentioned range decreases the drying property of the ink adhering to a recording medium, which also may lead to overflow of the ink on the recording medium, resulting in, for example, bleeding of the recorded image.

### 1.2. Water

The ink composition according to the embodiment may contain water. Water mainly functions as a medium for dispersing or dissolving a coloring material described below. The ink composition may be an aqueous ink containing 25% by mass or more of water or may be a non-aqueous ink containing less than 25% by mass of water, and preferred is an aqueous ink because of the effect of the specific alkanediol of the invention. The aqueous ink preferably contains 50% by mass or more of water.

### 1.3. Coloring Material

The ink composition according to the embodiment may contain a coloring material such as a pigment or a dye. The dyes and pigments described in U.S. Patent Publication Nos. 2010/0086690 and 2005/0235870 or International Publication No. WO2011/027842 can be preferably used. From the viewpoint of, for example, light resistance, pigments are preferred than dyes.

Usable examples of inorganic pigments include carbon blacks (C.I. Pigment Black 7), such as furnace black, lamp black, acetylene black, and channel black; iron oxide; and titanium oxide.

Examples of organic pigments include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates (e.g., basic dye chelates and acid dye chelates); dye lakes (e.g., basic dye lakes and acid dye lakes); and nitro pigments, nitroso pigments, aniline black, and daylight fluorescent pigments. These pigments may be used alone or in combination.

Usable examples of the dye include various dyes that can be usually used in ink jet recording, such as direct dyes, acid dyes, edible dyes, basic dyes, reactive dyes, disperse dyes, vat dyes, soluble vat dyes, and reactive disperse dyes.

The content of the coloring material in the ink composition can be appropriately determined depending on the use. For example, the content of the coloring material in an ordinary color ink can be 1.5% by mass or more. In a light color ink in which the concentration of the coloring material is lower than that in an ordinary color ink, the content of the coloring material can be 0.05% by mass or more and less than 1.5% by mass.

### 1.4. Other Additives

The ink composition may contain an organic solvent such as a polyhydric alcohol or a glycol ether, a resin for dispersing the pigment, a surfactant, and other components.

### Polyhydric Alcohol

Examples of the polyhydric alcohol include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, trimethylolpropane, 1,2-butanediol, 1,2-hexanediol, 1,2-heptanediol, and 1,2-octanediol.

### Glycol Ether

Examples of the glycol ether include lower alkyl ethers of polyhydric alcohols such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether.

From the viewpoint of reducing the VOC generation, it is preferred that the ink composition do not substantially contain an alkanediol having a normal boiling point of less than 240° C. It is further preferred that the ink composition do not substantially contain an organic solvent having a normal boiling point of less than 240° C.

Throughout the specification, “not substantially contain” means that, for example, the content is not higher than 1.0% by mass, preferably not higher than 0.5% by mass, more preferably not higher than 0.1% by mass, more preferably not higher than 0.05% by mass, more preferably not higher than 0.01% by mass, and most preferably not higher than 0.001% by mass, based on the total mass (100% by mass) of the ink.

### Resin

The resin contained in the ink composition functions as a dispersant for dispersing a pigment. Examples of the resin include, but not limited to, polyacrylic acid, polymethacrylic acid, polymethacrylate, polyethylacrylate, styrene-butadiene copolymers, polybutadiene, acrylonitrile-butadiene copolymers, chloroprene copolymers, fluororesins, vinylidene fluoride, polyolefin resins, cellulose, styrene-acrylic acid copolymers, styrene-methacrylic acid copolymers, polystyrene, styrene-acrylamide copolymers, polyisobutyl acrylate, polyacrylonitrile, polyvinyl acetate, polyvinyl acetal, polyvinylpyrrolidone, polyamide, rosin resins, fluorene resins, polyethylene, polycarbonate, vinylidene chloride resins, cellulose resins such as cellulose acetate butyrate, vinyl acetate resins, ethylene-vinyl acetate copolymers, vinyl acetate-acrylic copolymers, vinyl chloride resins, polyurethane, and rosin esters. These resins may be used alone or in combination.

The amount of the resin is preferably 10 parts by mass or more and 300 parts by mass or less and more preferably 50 parts by mass or more and 250 parts by mass or less based on 100 parts by mass of the pigment. Within this range, the pigment is further stably dispersed in water.

### Surfactant

The surfactant may be of any type and is preferably an acetylene glycol surfactant or polysiloxane surfactant. The acetylene glycol surfactant and polysiloxane surfactant enhance the wettability of the ink composition to a recording surface such as a recording medium to enhance the permeability of the ink composition.

The polysiloxane surfactant is, for example, a polyether modified organosiloxane. More specifically, examples of the polysiloxane surfactant include BYK-306, BYK-307, BYK-333, BYK-341, BYK-345, BYK-346, and BYK-348 (these are trade names of products manufactured by BYK-Chemie Japan, Inc.); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (these are trade names of products manufactured by Shin-Etsu Chemical Co., Ltd.).

Examples of the acetylene glycol surfactant include Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (these are trade names of products manufactured by Air Products and Chemicals Inc.); Olfine series B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (these are trade names of products manufactured by Nissin Chemical Industry Co. Ltd.), and Acetyrenol series E00, E00P, E40, and E100 (these are trade names of products manufactured by Kawaken Fine Chemicals Co., Ltd.).

The content of the surfactant in the ink composition is preferably 0.1% by mass or more and 1.5% by mass or less and more preferably 0.1% by mass or more and 1.0% by mass or less.

### Other Components

The ink composition may contain components (other components), in addition to the above-described components. Such components are, for example, a pH adjuster, an organic binder, a urea compound, a saccharide, and an alkanolamine (e.g., triethanolamine).

### 2. Ink Jet Recording Method

The ink jet recording method according to the embodiment records an image by discharging droplets of the ink composition from a recording head and allowing the droplets to adhere onto a recording medium. As a result, a recorded matter of the image recorded on the recording medium is provided.

The ink jet recording method according to the embodiment is performed with an ink droplet-discharging apparatus (for example, a known ink jet printer). The ink droplet-discharging apparatus may be a serial-type ink droplet-discharging apparatus (a printer employing a serial scanning head as the recording head) or may be a line-type ink droplet-discharging apparatus (a printer employing a line scan head as the recording head). In these ink droplet-discharging apparatuses, the recording head mounted thereon discharges ink droplets of the ink composition from the nozzle apertures at a predetermined volume (mass) and at a predetermined timing, while changing the relative position with the recording medium, and thereby allows the ink composition to adhere to the recording medium to record a predetermined image.

In general, in the serial-type ink droplet-discharging apparatus, the direction transporting a recording medium and the direction of reciprocating operation of the recording head cross each other. The relative position between a recording medium and the recording head is changed by combining the operation of reciprocating the recording head and the operation of transporting the recording medium (including reciprocating operation). In this case, the recording head is usually provided with a plurality of nozzle apertures (holes for discharging ink composition) so as to form a line of the nozzle apertures (nozzle line) along the recording medium-transporting direction. The recording head may be provided with a plurality of nozzle lines according to the number of types of ink compositions.

In general, in the line-type ink droplet-discharging apparatus, one of the recording head and the recording medium is not reciprocatingly operated, and the relative position between the recording medium and the recording head is changed by transporting the recording medium. In also this case, the recording head is usually provided with a plurality of nozzle apertures so as to form a line of the nozzle apertures (nozzle line) along a direction crossing the recording medium-transporting direction. Since the nozzle line is formed in the direction crossing the recording medium-transporting direction, i.e., over the width direction of the recording medium, the image-forming speed is particularly high in the width direction of the recording medium. Consequently, the line-type ink droplet-discharging apparatus can perform recording at a high speed. In this case, in order to further enhance the recording speed, the transporting speed of the recording medium in the transporting direction is preferably 30 cm/s or more, more preferably 50 cm/s or more, more preferably 80 cm/s or more, and most preferably 1 m/s or more and 50 m/s or less.

The relationship between the resolution of an image recorded on a recording medium and the number of nozzle apertures in a nozzle line provided to a recording head (hereinafter also referred to as “head resolution”) will now be described. If the head resolution is, for example, 360 apertures per inch (i.e., 360 dots per inch (dpi)), a line of dots is formed on a recording medium at 360 dpi so as to correspond to the arrangement of the nozzles in the nozzle line by discharging an ink composition from each nozzle aperture towards the recording medium. Even in the case of discharging ink droplets of the ink composition from each nozzle aperture while relatively moving the recording head and the recording medium in a direction crossing the nozzle line-extending direction, dots in the direction along the nozzle line direction are formed on the recording medium at a resolution of 360 dpi. That is, in this case, the resolution of the image (image resolution) in the direction along the nozzle line-extending direction is 360 dpi.

The intervals of ink droplets on a recording medium in a direction crossing the nozzle line direction of the recording head depend on the time intervals (discharge frequency) of discharging ink droplets from the nozzle apertures. When the recording head and the recording medium are relatively moved in the direction orthogonal to the nozzle line, the relationship between the image resolution and the head resolution is the same in the serial-type and line-type ink droplet-discharging apparatuses.

In the serial-type ink droplet-discharging apparatus, a recording medium can be moved in a direction crossing the direction of reciprocating operation of the recording head. Accordingly, even if the resolution of the recording head is, for example, 360 dpi, the dot intervals in the direction along the nozzle line of the image formed on the recording medium can be reduced by moving the recording medium. That is, the resolution of an image formed on a recording medium can be increased to twice the resolution in the direction along the nozzle line, i.e., 720 dpi, by performing recording on the recording medium by moving the recording head in the direction orthogonal to the nozzle line, then moving the recording medium in the direction along the nozzle line of the recording head by a distance, for example, a half of the dot interval, and performing recording again on the recording medium by moving the recording head in the direction orthogonal to the nozzle line. The movement distance of the recording medium in the direction along the nozzle line of the recording head can be set to be, for example, ⅓, ¼, or ⅛ of the dot interval. Accordingly, an image having a resolution higher than the head resolution can be easily formed. In the case of increasing the image resolution by this procedure, however, it must be noted that there is a tradeoff between the image resolution and the image recording time length.

In the ink jet recording method with an ink droplet-discharging apparatus, an enlargement in the size of ink droplets (liquid droplets) can increase the recording speed but decreases the drying property of the ink adhered to a recording medium, which may cause overflow of the ink on the recording medium or an increase in the granular quality of the image, resulting in a reduction in the image quality. However, the ink jet recording method according to the embodiment uses the above-described ink composition having excellent balance between the drying property and the permeability and thereby can record an image with excellent image quality having low overflow and granular quality even when the ink droplets have large sizes. Specifically, the ink jet recording method according to the embodiment can be suitably used for recording images by ink droplets each having a volume of 5 pL or more and 30 pL or less. That is, the ink droplets of the ink composition discharged from the recording head have a volume of 5 pL or more and 30 pL or less per droplet; the ink droplet volume for emphasizing the drying property is preferably 7 pL or more and 20 pL or less; and the ink droplet volume for emphasizing the recording speed is preferably 10 pL or more and 30 pL or less. Though not all the liquid droplets for forming an image are required to have volumes within these ranges, 50% or more of the discharged ink droplets in recording of an image preferably have volumes within the ranges. The discharge of ink droplets of multiple sizes, i.e., the discharge of ink droplets having different sizes (for example, in a range of 1 to 40 pL), in formation of an image allows flexible switching between emphasis of recording speed and emphasis of drying property during the image recording. The ink droplets of multiple sizes can be discharged by, for example, changing the discharge waveform with an ink jet system including piezoelectric elements.

The ink jet recording method according to the embodiment can be applied to recording of images using ink droplets having a volume of less than 5 pL. A small ink droplet size of less than 5 pL hardly causes a reduction in drying property of the adhering ink droplets, but causes a reduction in recording speed.

The volume of ink per droplet can be measured with, for example, an ink jet liquid droplet automatic measurement device (trade name: “JetMeasure”, manufactured by Microjet corporation) on the basis of the volumes of ink droplets during flying. The flying time of a liquid droplet refers to the time from discharge of the liquid droplet from a nozzle to adhesion (contact) of the liquid droplet onto a recording medium. A single liquid droplet discharged from a nozzle may be divided into a plurality of droplets at the time of parting from the nozzle or during flying. In such a case, the measurement is based on the volume (pL) of the largest droplet among the plurality of liquid droplets.

In the ink jet recording method using a serial-type ink droplet-discharging apparatus, a reduction in the ratio (R1/R2) of the image resolution (R1) in the recording medium-transporting direction to the head resolution (R2) in the recording medium-transporting direction can decrease the operation of the recording head and thereby allows high-speed recording. For example, in a known ink jet recording method using a serial-type ink droplet-discharging apparatus, the image resolution in the recording medium-transporting direction is 8 times the head resolution in the transporting direction. However, in the ink jet recording method according to the embodiment using a serial-type ink droplet-discharging apparatus, the image resolution in the recording medium-transporting direction is 6 times or less (preferably 1 time or more and 4 times or less) the head resolution in the transporting direction. In addition, a recording method by alternately repeating scanning of the recording head (main scanning) and transporting of the recording medium (sub-scanning) is also preferred. Even in such high-speed recording, since an ink composition having excellent balance between drying property and permeability is used, the resulting image can have excellent image quality having low overflow and granular quality.

In the case of a low resolution per unit length of the recording head, the recording speed is usually apt to be slow when the size of ink droplets is not increased. However, an increase in the size of ink droplets tends to disadvantageously cause a reduction in image quality as described above. The ink jet recording method according to the embodiment can record an image with excellent image quality without causing the disadvantage even if the ink droplet size is increased. Accordingly, the ink jet recording method according to the embodiment can be suitably applied to a recording head having a low resolution of 200 dpi per unit length. Specifically, the recording head preferably has a resolution of 200 dpi or more, more preferably 200 dpi or more and 800 dpi or less, per unit length. The ink jet recording method according to the embodiment can also be applied to a case of a head resolution exceeding 600 dpi. A high density head exceeding 800 dpi discharges ink droplets having a small size and thereby hardly causes a reduction in drying property of the adhering ink droplets.

In order to record an image having a high resolution, i.e., an image having an image resolution exceeding 1200 dpi in the recording medium-transporting direction and an image resolution exceeding 1200 dpi in a direction crossing the transporting direction, it is necessary to reduce the size of the ink droplets discharged from a recording head. Ink droplets having a small size hardly cause a reduction in the drying property of adhering ink droplets. Accordingly, the ink jet recording method according to the embodiment is preferably used for recording an image having an image resolution of 1200 dpi or less in the recording medium-transporting direction and an image resolution of 1200 dpi or less in a direction crossing the transporting direction.

The nozzle aperture preferably has a diameter of 15 μm or more and 30 μm or less and more preferably 20 μm or more and 30 μm or less. A diameter of the nozzle aperture within the range allows stable discharge of an ink and also allows easy achievement of discharge of the above-described ink droplets.

The ink jet recording system employs the above-described serial-type or line-type ink droplet-discharging apparatus, and the system itself may be any system that can discharge an ink composition as ink droplets from fine nozzle apertures and allow the ink droplets to adhere onto a recording medium. Examples of the ink jet recording system include electrostatic aspiration systems, systems ejecting ink droplets by means of pump pressure, systems using piezoelectric elements, and systems ejecting ink droplets by means of foam formed by heating an ink solution with a microelectrode. Among these systems, the system using piezoelectric elements is preferred.

The ink jet recording method according to the embodiment using the above-described ink composition can reduce the VOC generation from the recorded image and also simultaneously achieve both high image quality and high speed recording.

Examples of the recording medium used in the ink jet recording method according to the embodiment include, but not limited to, paper, fiber products, leather, sheets or films, plastics, glass, ceramics, and metals.

### 3. Examples

The embodiments of the invention will now be more specifically described by examples and comparative examples, but the invention is not limited to the following examples.

### 3.1. Preparation of Ink Composition

Table 1 shows ink compositions. The ink compositions prepared were dark ink compositions (common color inks) of yellow (Y), magenta (M), cyan (C), and black (K) and light ink compositions (light color inks) of light magenta (Lm), light cyan (Lc), gray (Lk), and light gray (LLk).

The pigments in the ink compositions were Pigment yellow 74 for the yellow (Y) ink, Pigment blue 15:3 for the cyan (C) and light cyan (Lc) inks, Pigment violet 19 for the magenta (M) and light magenta (Lm) inks, and carbon black for the black (K), gray (Lk), and light gray (LLk) inks. The content of each pigment is shown in Table 1.

The pigment, a styrene-acrylic acid copolymer (weight-average molecular weight: 78000, resin acid value: 100), and deionized water (a part) were mixed by stirring. The mixture was subjected to dispersion treatment using zirconia beads (diameter: 1.5 mm) with a sand mill (manufactured by Yasukawa Seisakusyo K. K.) for 6 hours. Subsequently, the zirconia beads were removed with a separator to give each pigment dispersion.

The resulting pigment dispersions were mixed with glycerin, a surfactant (product name: “BYK-348”, a silicon-containing surfactant manufactured by BYK-Chemie Japan, Inc.), triethanolamine, a penetrant shown in Table 2, and deionized water so as to give the compositions shown in Table 1. Subsequently, each mixture was stirred at room temperature for 1 hour and was then filtered through a membrane filter with a pore size of 5 μm to prepare each ink composition. The numerical values shown in Table 1 are contents (in terms of % by mass) in each ink.

The abbreviations of penetrants shown in Table 2 refer to the following compounds:

MPD: 3-methyl-1,5-pentanediol (normal boiling point: 265° C.)

1,6-HD: 1,6-hexanediol (normal boiling point: 250° C.)

1,2-HD: 1,2-hexanediol (normal boiling point: 223° C.)

1,3-PD: 1,3-propanediol (normal boiling point: 210° C.)

TABLE 1
Unit: % by mass

| | Dark ink composition | | | | Light ink composition | | | |
|---|---|---|---|---|---|---|---|---|
| | Y | M | C | K | Lm | Lc | Lk | LLk |
| Pigment | 5 | 5 | 4 | 2 | 1 | 1 | 0.8 | 0.3 |
| Glycerin | 10 | 10 | 10 | 15 | 22 | 22 | 22 | 24 |
| Surfactant (BYK-348) | 0.5 | 0.6 | 0.4 | 0.5 | 0.5 | 0.5 | 0.5 | 0.5 |
| Triethanolamine | 1 | 1 | 1 | 1 | 1 | 1 | 1 | 1 |
| Resin (dispersant) | 3 | 3 | 2.8 | 2.5 | 2 | 2 | 1.2 | 0.6 |
| (styrene-acrylic acid copolymer) | | | | | | | | |
| Penetrant solvent | See Table 2 | | | | | | | |
| Water | balance | balance | balance | balance | balance | balance | balance | balance |

### 3.2. Method of Evaluation

Each evaluation test was performed with an ink jet printer (Model: PX-H8000, manufactured by Seiko Epson Corporation) provided with each ink composition according to Examples and Comparative Examples under the following recording conditions 1 to 5.

Recording Condition 1:

Ink droplet size: 45 pL, 30 pL, 15 pL

Image resolution: 300 dpi vertical and 600 dpi horizontal

Recording Condition 2:

Ink droplet size: 30 pL, 20 pL, 10 pL

Image resolution: 600 dpi vertical and 600 dpi horizontal

Recording Condition 3:

Ink droplet size: 15 pL, 10 pL, 5 pL

Image resolution: 600 dpi vertical and 1200 dpi horizontal

Recording Condition 4:

Ink droplet size: 7 pL, 4.7 pL, 2.4 pL

Image resolution: 1200 dpi vertical and 1200 dpi horizontal

Recording Condition 5:

Ink droplet size: 3 pL, 2 pL, 1 pL

Image resolution: 1200 dpi vertical and 2400 dpi horizontal

The term “vertical” in the image resolution refers to the image resolution in the recording medium-transporting direction. The term “horizontal” refers to the image resolution in a direction crossing the recording medium-transporting direction. The ink jet printer is a serial-type printer and has a head resolution of 360 dpi in the recording medium-transporting direction.

### 3.2.1. Evaluation of VOC Generation

The VOC generation was evaluated using an ink jet printer (Model: PX-H8000, manufactured by Seiko Epson Corporation) in accordance with the measuring process and evaluation conditions by The Blue Angel (German Institute for Quality Assurance and Labelling). Criteria of judgment are as follows:

Judgment of VOC:

Good: VOC generation of 5 mg/hr or less, and

Poor: VOC generation of exceeding 5 mg/hr.

### 3.2.2. Evaluation of Graininess

The graininess was evaluated in accordance with a monograph “The evaluation of image quality in ink jet recording” by The Imaging Society of Japan (Japan hardcopy '99 Proceedings (pp. 291-294)). Specifically, dedicated images for evaluating graininess (gradation patches) were recorded using ink sets according to Examples and Comparative Examples. The resulting recorded matters were scanned with a scanner and were processed into electronic data, and graininess index values were calculated with dedicated software. The recording medium used was photographic paper “Gloss” (manufactured by Seiko Epson Corporation). The scanner used was GT-X770 (manufactured by Seiko Epson Corporation), and the image data was collected at a resolution of 1200 dpi and an analysis object region of 256×256 pixels as analytical data. The graininess was evaluated based on the calculated graininess index values according to the following criteria:

Judgment of Graininess:

Good: graininess index of less than 0.28,

Fair: graininess index of 0.28 or more and less than 0.30, and

Poor: graininess index of 0.30 or more.

### 3.2.3. Evaluation of Overflow

The dedicated images for evaluating graininess (gradation patches) prepared in “Evaluation of graininess” were visually observed to judge the overflow in each image. Criteria of judgment are as follows:

Judgment of Overflow:

Good: no overflow, and

Poor: occurrence of overflow.

### 3.3. Evaluation Results

Table 2 shows the evaluation results of the above-described tests.

TABLE 2

| | |
|---|---|
| Penetrant | Volume |

| | | of content | | of ink | Evaluation results | | |
|---|---|---|---|---|---|---|---|
| | Type of | (% by | Printing | per droplet | VOC | | |
| | penetrant | mass) | condition | (average) | judgment | Graininess | Overflow |
| Example 1 | MPD | 5 | Condition 2 | 30 pL | good | fair: 0.28 | good |
| Example 2 | MPD | 5 | Condition 3 | 15 pL | good | good: 0.19 | good |
| Example 3 | MPD | 5 | Condition 4 | 7 pL | good | good: 0.17 | good |
| Example 4 | MPD | 10 | Condition 2 | 30 pL | good | good: 0.27 | good |
| Example 5 | MPD | 20 | Condition 2 | 30 pL | good | good: 0.27 | good |
| Example 6 | 1,6-HD | 5 | Condition 2 | 30 pL | good | fair: 0.29 | good |
| Comparative | 1,2-HD | 5 | Condition 2 | 30 pL | poor | good: 0.27 | good |
| Example 1 | | | | | | | |
| Comparative | 1,3-PD | 5 | Condition 2 | 30 pL | poor | poor: 0.34 | poor |
| Example 2 | | | | | | | |
| Comparative | 1,3-PD | 5 | Condition 4 | 7 pL | poor | good: 0.23 | poor |
| Example 3 | | | | | | | |
| Comparative | 1,3-PD | 5 | Condition 5 | 3 pL | poor | good: 0.19 | good |
| Example 4 | | | | | | | |
| Comparative | MPD | 5 | Condition 1 | 45 pL | good | poor: 0.42 | poor |
| Example 5 | | | | | | | |
| Comparative | MPD | 1 | Condition 2 | 30 pL | good | poor: 0.30 | good |
| Example 6 | | | | | | | |
| Comparative | MPD | 25 | Condition 2 | 30 pL | good | fair: 0.29 | poor |
| Example 7 | | | | | | | |

In Examples and Comparative Examples, the resolution of each image in the recording medium-transporting direction was 6 times or less the head resolution in the transporting direction to perform high speed recording. In this case, Examples demonstrated that images with excellent image quality having low overflow and granular quality were recorded even when the ink droplets had large sizes, 30 pL. In addition, the ink compositions in Examples each contained an alkanediol having 6 or less carbon atoms and having a normal boiling point of 240° C. or more and thereby showed good VOC evaluation results.

On the contrary, the ink compositions in Comparative Examples 1 to 4 each contained an alkanediol having a normal boiling point of less than 240° C. and thereby showed poor VOC evaluation results.

The ink compositions in Comparative Examples 2 and 3 showed poor evaluation results in at least one of overflow and graininess, which demonstrated that these ink compositions were unsuitable for high-speed recording.

Comparative Example 5 demonstrated that excessively large ink droplets having a size of 45 pL were poor in graininess and overflow.

The ink composition in Comparative Example 6 contained an alkanediol having 6 or less carbon atoms and having a normal boiling point of 240° C. or more in a too small amount and thereby showed poor graininess and overflow evaluation results.

The ink composition in Comparative Example 7 contained an alkanediol having 6 or less carbon atoms and having a normal boiling point of 240° C. or more in a too large amount and thereby showed poor graininess and overflow evaluation results.

The invention is not limited to the above-described embodiments, and various modifications are possible. For example, the invention includes methods or compositions that are substantially the same as those described in the embodiments (for example, a composition involving in the same function, method, and result, or a composition having the same object and effect). The invention includes methods or compositions in which parts not essential in the embodiments described above are replaced with other. The invention also includes methods or compositions that achieve the same functions and effects or achieve the same objects of those described in the embodiments. In addition, the invention includes methods or compositions involving known techniques added to those described in the embodiments.

What is claimed is:

1. An ink jet recording method of recording an image by allowing ink droplets of an ink composition discharged from a recording head to adhere onto a recording medium, wherein
the ink composition contains 3% by mass or more and 20% by mass or less of an alkanediol having 6 or less carbon atoms and having a normal boiling point of 240° C. or more;
the ink droplets of the ink composition have a volume of 5 pL or more and 30 pL or less per droplet; and
the recording head is a serial scanning head or a line scan head, wherein
in a case of the recording head being a serial scanning head, the image resolution in the recording medium-transporting direction is 6 times or less the head resolution in the transporting direction.

2. The ink jet recording method according to claim 1, wherein
the recording head has a resolution of 200 dpi or more and 800 dpi or less per unit length.

3. The ink jet recording method according to claim 1, wherein
the image resolution in the recording medium-transporting direction is 1200 dpi or less, and the image resolution in a direction crossing the transporting direction is 1200 dpi or less.

4. The ink jet recording method according to claim 1, wherein
in a case of the recording head being a line scan head, the transporting speed of the recording medium in the transporting direction is 30 cm/s or more.

5. The ink jet recording method according to claim 1, wherein
the alkanediol has a branched structure.

6. The ink jet recording method according to claim 1, wherein
the alkanediol is 3-methyl-1,5-pentanediol.

7. The ink jet recording method according to claim 1, wherein
the recording head discharges ink droplets having different sizes to form the image.

8. A recorded matter prepared by the ink jet recording method according to claim 1.

9. A recorded matter prepared by the ink jet recording method according to claim 2.

10. A recorded matter prepared by the ink jet recording method according to claim 3.

11. A recorded matter prepared by the ink jet recording method according to claim 4.

12. A recorded matter prepared by the ink jet recording method according to claim 5.

13. A recorded matter prepared by the ink jet recording method according to claim 6.

14. A recorded matter prepared by the ink jet recording method according to claim 7.
